(19) United States
(12) Patent Application Publication
(10) Pub. No.: US 2019/0220848 A1
(43) Pub. Date: Jul. 18, 2019

(54) Linked Data Structures

(71) Applicant: Bitmo, Inc., Carlsbad, CA (US)

(72) Inventors: James Michael Smallwood, Carlsbad, CA (US); David Marc Peace, Escondido, CA (US)

(73) Assignee: Bitmo, Inc., Carlsbad, CA (US)

(21) Appl. No.: 16/248,571

(22) Filed: Jan. 15, 2019

Related U.S. Application Data
(60) Provisional application No. 62/617,980, filed on Jan. 16, 2018.

(51) Int. Cl. G06Q 20/34; G06F 16/23; G06Q 20/10; G06Q 20/20; G06Q 20/36; G06Q 20/38

(52) U.S. Cl. CPC G06Q 20/342; G06F 16/23; G06Q 20/10; G06Q 20/389; G06Q 20/204; G06Q 20/36; G06Q 20/346

(57) ABSTRACT

Disclosed are database systems and methods of managing them. In one embodiment, a linked data structure is disclosed to enable failure tracking, data integrity and security for the underlying data. The disclosed data structures can embed one or more databases configured to store program instructions, program sub-instructions and mappings designed for failure detection, tracing and restoration of databases to their pre-failure state.

### CROSS-REFERENCE TO RELATED APPLICATIONS

This application claims the benefit of priority of U.S. Provisional Application No. 62/617,980 filed on Jan. 16, 2018 entitled “Linked Data Structures,” content of which is incorporated herein by reference in its entirety and should be considered a part of this specification.

### BACKGROUND

### Field of the Invention

This invention relates generally to software, and more particularly, to software managing and processing database structures.

### Description of the Related Art

Some applications of database structures include creating database data, associating the data with users and their activity and handling sensitive data associated with the users and their activity. Failure tracking and recovery in such large databases can present technical and implementation challenges to conventional database structures.

Additionally, some applications of database software demand handling financial transactions of a large user base with security and integrity in an efficient manner. One application of database management and processing systems and methods include database structures designed to handle gift card transaction within a large user community. Currently, merchants wishing to accept prepaid methods of payment, for example gift cards, need to implement a payment processing system dedicated to accepting and processing prepaid payments or gift cards. These independent and dedicated gift card processing systems cost merchants and there is a need for database software and methods to implement gift card issuance and processing systems that work through a merchant's existing payment processing systems.

Some statistics suggest 93% of American consumers use gift cards. In some cases, consumers receive gift cards that they may have no use for or may wish to exchange. A staggering number of gift cards are lost and go unredeemed. Merchants lose business as a result. Existing gift card systems do not allow for efficient management of gift cards. Additionally, conventional software can be inefficient or incapable of creating and managing the data structures and systems that can provide failure tracking, recovery, security and data integrity demanded in gift card issuance and processing systems. Consequently, a need exists for improved databases and systems and methods of database management that addresses the issues above.

### SUMMARY

In one aspect of the invention, an electronically-implemented method is disclosed. The method includes: receiving an input from a first user indicating a first type and a first value of a gift card; receiving a request from the first user to donate the gift card to a second user; updating a transactions database with program instructions associated with the first user's request; updating a ledger lines database with program sub-instructions to carry out the first user's request; updating a transaction ledger lines database with a mapping of data in the transactions database and data in the ledger lines database; and executing the program instructions in the transactions database and the program sub-instructions in the ledger lines database.

In one embodiment, program sub-instructions comprise computer instructions to: withdraw funds in the amount of the first value from a bank account of the first user; credit a first user's account in an accounts database in the amount of the first value; update a cards database by associating a virtual gift card of the first value and the first type to the first user; debit the first user's account in the accounts database in the amount of the first value; debit the virtual gift card of the first user in the cards database in the amount of the first value; credit an account of the second user in the accounts database in the first value; generate, in the cards database, a virtual gift card associated with the second user in the amount of the first value.

In another embodiment, the method further includes: receiving a modification request from the second user for modifying the first type or the first value of the virtual gift card associated with the second user; and updating the transactions database, the ledger lines database and the transaction ledger lines with program instructions to modify the virtual gift card associated with the second user according to the modification request.

In one embodiment, the method further includes: receiving a request from the second user for redeeming the virtual gift card associated with the second user; purchasing, from a gift card provider, a gift card in the value and type of the virtual gift card; and presenting an identifier to the second user, wherein the identifier corresponds to the purchased gift card.

In some embodiments, modification request comprises: adding, splitting, combining, or exchanging the virtual gift card associated with the second user for another type and/or value.

In one embodiment, the method further includes: providing a proxy payment card associated with the second user, wherein the second user can use the proxy payment card at a point of sale to purchase in the amount associated with the modified virtual gift card, in an amount less than or equal to the modified virtual gift card or in an amount more than the modified virtual gift card, wherein the remainder amount is supplemented automatically from other virtual gift cards associated with the second user.

In one embodiment, the proxy payment card is provisioned in a digital wallet, implemented in a physical card or both.

In some embodiments, the transaction ledger lines database is used to trace an error in executing program instructions and/or program sub-instructions.

In one embodiment, the method further includes: authenticating the first user with cell phone career data and/or two-factor authentication.

In another aspect of the invention, a linked data structure is disclosed. The data structure includes: a users database configured to receive and store identification and authentication information of a plurality of users; a transactions database configured to receive instructions associated with managing gift card transitions and gift card transactions of the plurality of users; a ledger lines database configured to store one or more program sub-instructions based on the instructions associated with managing gift card transitions and gift card transactions; a transaction ledger lines database configured to generate and store a mapping of data in the transactions database and data in the ledger lines database; and a cards database configured to generate and store virtual gift cards associated with the plurality of users in the users database.

In one embodiment, the linked data structure further includes: a payment methods database configured to receive and store one or more payment methods associated with the plurality of users, wherein payment methods comprise links to bank accounts of the plurality of the users and sub-instructions comprise program code to withdraw funds from the bank accounts in the amount of the virtual gift cards.

In one embodiment, the instructions in the transactions database comprise instructions from a first user to purchase a gift card of a first value and first type and donate the gift card to a second user.

In one embodiment, the linked data structure further includes an accounts database and the sub-instructions in the ledger lines include instructions to: withdraw funds in the amount of the first value from a bank account of the first user; credit a first user's account in the accounts database in the amount of the first value; update the cards database by associating a virtual gift card of the first value and the first type to the first user; debit the first user's account in the accounts database in the amount of the first value; debit the virtual gift card of the first user in the cards database in the amount of the first value; credit an account of the second user in the accounts database in the first value; generate, in the cards database, a virtual gift card associated with the second user in the amount of the first value.

In one embodiment, the instructions in the transactions database further comprises instructions based on a request from the second user to modify the type and value of the virtual gift card associated with the second user.

In another embodiment, the request from the second user comprises: adding, splitting, combining, or exchanging the virtual gift card associated with the second user for another type and/or value.

In some embodiments, the sub-instructions comprise updating the transactions database, the ledger lines database and the transaction ledger lines with program instructions to modify the virtual gift card associated with the second user according to the request from the second user.

In one embodiment, the instructions in the transactions database further comprises instructions based on a user's request to redeem a virtual gift card and the sub-instructions comprise instructions to purchase a gift card from a gift card vendor in the amount and value of the virtual gift card.

In another embodiment, the instructions in the transactions database and the sub-instructions in the ledger lines database are generated to support usage of proxy payment cards associated with the virtual gift cards.

In one embodiment, the mapping in the transaction ledger lines database is used to trace a failure in a gift card transition and/or a gift card transaction.

In one embodiment, a mobile application is disclosed, which is capable of using the disclosed linked data structures.

### BRIEF DESCRIPTION OF THE DRAWINGS

These drawings and the associated description herein are provided to illustrate specific embodiments of the invention and are not intended to be limiting.

FIG. 1 illustrates a gift card system, which can be implemented using the described linked data structures.

FIG. 2 illustrates a method for provisioning of a proxy payment card to a user's digital wallet using the described linked data structures.

FIG. 3 illustrates a method used to issue a physical payment card to a user of the described gift card system built according to an embodiment of the described data structures.

FIG. 4 illustrates a gift card system that operates via a merchant's existing payment rails.

FIG. 5 illustrates a linked data structure according to an embodiment.

FIG. 6 illustrates an exemplary payment failure tracking according to an embodiment.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Currently some merchants provide a feature in their payment processing system allowing customers to use a prepaid method of payment. Prepaid method of payment can include for example gift cards. Current prepaid payment systems suffer from deficiencies. For example, according to some statistics, nearly 40% of issued gift cards are lost or are otherwise unused. Retailers both online and physical lose customer traffic due to unused and unclaimed gift cards, thereby losing on brand loyalty and possible derivative business opportunities from customers who would otherwise patronize the merchant.

Technical challenges have prevented digitization and modernization of the prepaid payment industry. In some cases, the improvement to the field has been limited to merely storing static gift card information without more. The described technology improves the field in ways not previously disclosed allowing a more dynamic and controlled consumer experience with the gift card industry.

One use of prepaid payment systems and methods is for the purpose of making gifts. Gift cards exist and are used to pay for goods or services up to a desired value on behalf of a gift card recipient. Conventional gift card systems typically issue a plastic card with magnetic stripe. The recipient can use the gift card at an associated retailer to purchase goods or services up to the prepaid value. In some cases, a recipient of a conventional gift card may have no desire or use for the prepaid services or goods linked to the received gift card and may wish to exchange the received gift card for another seller whose goods or services are more desirable to the recipient. In other cases, the recipient of a gift card may wish to gift the received gift card to another person, or may wish to exchange the value of a gift card from one seller to a similar value gift card of another seller and gift the exchanged gift card to another person. In other cases, the recipient of a gift card may wish to split the value of a received gift card and exchange some of the value of a received gift card for the gift card of another seller and retain a portion of the originally received gift card.

In a conventional gift card system, the recipient has little to no flexibility to exchange, split or otherwise make changes to the originally issued gift card. Gift card recipients of a conventional gift card system are prone to lose track of their gift cards, not know the balance on the gift card or be unable or unwilling to use the issued gift card. By contrast, the disclosed infrastructure and technology allows consumers the flexibility to manipulate and manage multiple gift cards, their associated value and their linked merchants, without incurring third party costs.

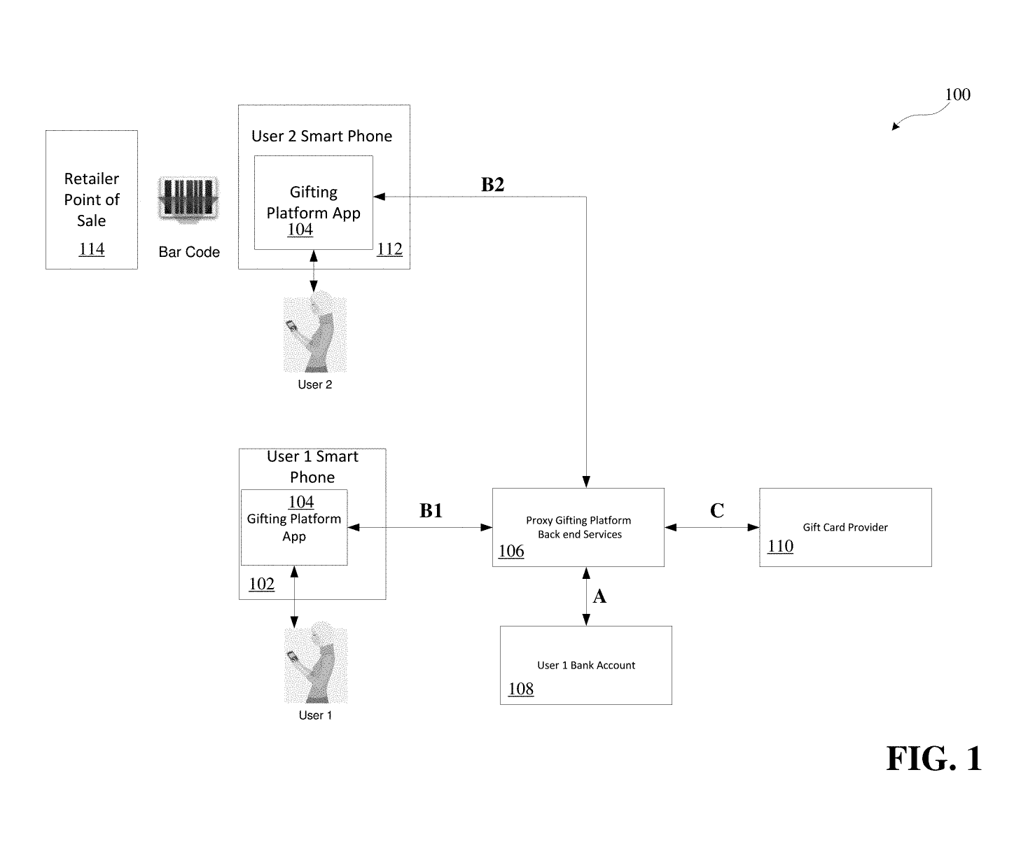

FIG. 1 illustrates a gift card system 100, in which an embodiment is used to address the issues described above. User 1, utilizing a smart phone 102 can access a gifting platform application 104. The gifting platform application 104 can be in communication with a proxy gifting platform backend services 106. User 1 can link a bank account 108 to the proxy gifting platform backend services 106. User 1 can utilize the gifting platform application 104 to issue a request to debit the bank account 108 to purchase one or more gift cards. The proxy gifting platform backend services 106 can route the request to the financial institution maintaining the User 1 bank account 108 and facilitate the transfer of funds in the amount requested by User 1. In one embodiment, the transferred funds can be kept in a general bank account managed held in a financial institution with the operator of the system 100 as the account holder.

The proxy gifting platform backend services 106 keeps track of User 1's account, for example via a ledger entry associated with User 1 in the described linked data structures. The backend services 106 can be in communication with one or more gift card providers 110. The gift card providers 110 may be providers that have relationship with stores that offer prepaid services such as gift cards. Examples of gift card providers include Tango Card® of Seattle, Wash. (Tel: 877-558-2646) and Blackhawk Network of Pleasanton, Calif. (Tel: 925-226-9990). In some embodiments, ledgers can utilize a blockchain or a modified blockchain approach. In some embodiments, ledgers are data structures that maintain mappings or tables to facilitate the functions and implementations of the embodiments described herein. For example, data structures are described to keep track of an amount of gift card value from inception to expiration or expenditure as the value associated with the gift card changes hands between multiple users or is split, combined and/or is exchanged.

Additionally, the disclosed embodiments, provide systems and methods to implement a digital gift card system, without subjecting the operators of the embodiments described herein to financial or regulatory regimes commonly applied to financial institutions, such as banks. For example, the currency value of an account of a user of the embodiments described herein can reside in a traditional financial institution, thereby absolving the operator of the systems and methods described herein from having to abide by all or some of the governmental regulations applied to financial institutions. Accordingly, an operator of the described systems and methods in some embodiments, can be considered a software provider, not a financial institution.

In some embodiments, a new user of the gift card system 100 and other described gift card systems can provision the gifting platform application 104 from a digital application store to her mobile computing device 102. Examples of mobile computing device stores include Apple® App Store, Google® Android Market or similar digital stores. The user can create an account inputting personally identifying information (Pii). The described gift card systems can perform know your customer (KYC) checks when creating a new account for a user. In some embodiments, during initial registration, information regarding the User 1 smart phone 102 can be associated with the User 1 account and saved in the backend services 106. Information such as carrier information of smart phone 102, location of smart phone 102, and other device information can be obtained and recorded to use for identification, authentication and fraud risk management. A ledger entry associated with User 1 is created in the backend services 106 to store and track the user's gift card values and activity. In some embodiments, the user can enter a payment method to fund the purchase of gift cards for the purposes of donating and gifting, can create and populate a profile, subscribe and/or view a social stream to see other user's activity on the gift card system 100.

The gifting platform application 104 can support gift cards that are available through the providers 110 and can present a list of such gift cards to the User 1 via for example a catalogue of available gift cards. User 1 can choose to purchase a gift card via entering an input into the gifting platform application 104, for example, via a touch screen or other input device. In some embodiments, when User 1 chooses to purchase a gift card, the backend services 106 debits User 1's account and generates or updates a database containing a mapping of User 1's purchased gift cards, their respective values and one or more personally identifying information (Pii) of User 1.

In some traditional gift card systems, when the user authorizes the purchase of a gift card, the traditional gift card system purchases the authorized gift card from a gift card provider and subsequently the ability of the user to exchange or return the purchased gift card, without losing some gift card value, is limited. In some cases, a user who has changed his mind needs to go through a third-party gift card exchange provider to exchange or return a gift card and the user usually loses some value of the gift card in the exchange. Such exchanges are undesirable and time consuming for the consumer and the unwanted gift card goes unused.

In some embodiments, when User 1 authorizes or requests the purchase of a gift card, the proxy gifting platform backend services 106 debits User 1's bank account and creates a virtual gift card. It also updates the database table associated with User 1 with the type and information of the authorized gift card and the value of the gift card. The backend services 106 does not purchase or redeem the authorized gift card from the gift card provider 110 until User 1 or a gift card recipient, for example User 2, is at a point of sale in an online or physical store ready to make a purchase with the gift card. User 1's initial authorization and purchase of the gift card via gifting platform application 104 is virtual, and as such the user is free to change her mind and exchange one merchant's gift card for another, change the value or return the gift card altogether. Any changes at the first purchase stage can be accomplished via one or more exchanges B1 in FIG. 1 between the gifting platform application 104 which received User 1's inputs and the backend services 106. The database table associated with User 1 is updated when User 1 requests a change to the virtual gift card status, type, value, etc.

User 1 can also gift a virtual gift card to User 2 who may or may not be an existing user of the gifting platform application 104. If User 2 is already a user of the gifting application 104, User 2 receives an in-app notification or other notification based on her pre-selected preferences (e.g., via text or email). If User 2 is not a user of the gift card system 100, she receives a notification to obtain the application 104 on her computing device 112 to receive the virtual gift card gifted by User 1. A database table entry is created or updated for User 2. The gifting application 104 updates both User 1 and User 2's database tables to reflect the transfer of the virtual gift card between the two users. Similarly, User 2 can view the type, value and status of her virtual gift cards in gifting application 104 and make changes if she wishes and those changes will be reflected in the database table associated with User 2. In the pre-redemption stage, User 2 can view, exchange, partial exchange, combine or return the virtual gift card via one or more exchanges B2 in FIG. 1. User 2 can also gift the received gift card from User 1 to another user, split and gift to more than one user, retain some and gift a portion or combine virtual gift cards and gift to one or more users. User 1 and User 2's gift cards in the pre-redemption stage are virtual gift cards and changes can be affected for an unlimited number of times as the users may wish. The changes are reflected in the backend services 106. The virtual nature of the gift cards in the pre-redemption stage allows a donor or a recipient to exchange, re-exchange, gift, re-gift, combine or split the virtual gift cards.

When a user wishes to use a virtual gift card to make a purchase at the point of sale 114, the user can redeem the virtual gift card via inputting a request for redemption via the gifting platform application 104. The backend services 106 communicates with a gift card provider 110 who can provide the type and value of the virtual gift card to be redeemed. The gift card provider can debit a bank account associated with the provider of the gifting system 100 and issue a gift card in the requested type and value by providing an identifier (e.g., a barcode) to the backend services 106. The backend services 106 can provide the redeemed gift card identifier (e.g., bar code) to the gifting platform application 104. The user can present the redeemed gift card identifier at the point of sale 114. The merchant operating the point of sale 114 enters the gift card information via its own gift card processing system (via for example, bar code scanning or manual entry of an identifier) and processes the point of sale transaction. If the transaction is occurring online, the user may enter the redeemed gift card information (e.g., a bar code) to complete a transaction.

In another embodiment, a proxy payment method such as a bank card or digital wallet found on modern mobile devices can be used to implement a digital gifting platform, which offers the benefits described above. A gift card account is associated with a user's bank card or a payment credential in the user's digital wallet. Examples of a digital wallet include Apple Pay® and Android Pay®. The payment credential can become a proxy into a user's gift card account. The gifting platform can issue a payment credential to be provisioned in the user's digital wallet. The user need not redeem a virtual gift card or keep track of gift card values or types. Merchants need not utilize a dedicated gift card processing system to process the transactions linked to a user's gift card account.

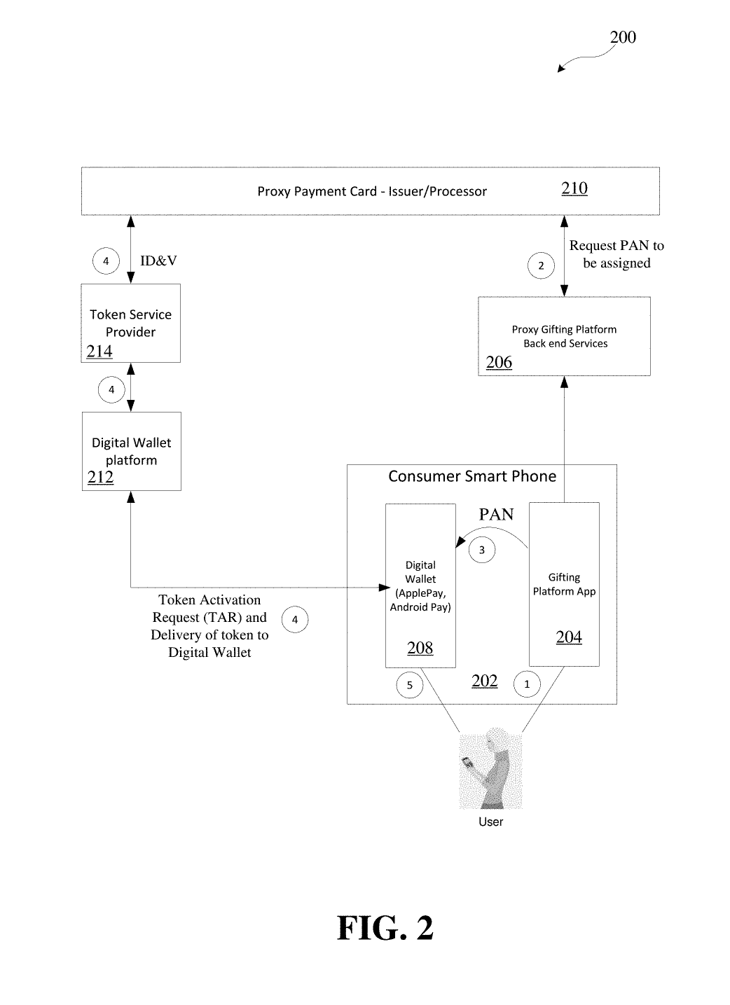

FIG. 2 illustrates a method 200 for provisioning of a proxy payment card linked with a user's gift card account to the user's digital wallet for the purpose of utilizing a gift card system according to an embodiment. The term proxy payment card is utilized to indicate a type of payment, which is a proxy to a user's gift card account. User can choose to create a proxy payment card to be added to her digital wallet by inputting a request via exchange 1 with the gifting platform app 204. The gifting platform app 204 routes the request to the backend services 206 which sends a request, to an issuer/processor 210 to assign a Primary Account Number (PAN) via exchange 2. The processor/issuer 210 issues and returns a PAN to the backend services 206 via exchange 2. Via Exchange 3, the gifting platform app 204 forwards the PAN to the digital wallet 208. The digital wallet 208 adds the proxy payment card by sending a Tokenization Activation Request (TAR) to a Token Service Provider (TSP) 214 via one or more exchanges 4. When the TAR process is complete, the proxy payment card is provisioned to the digital wallet 208 for selection as with any other provisioned payment card. It is also visible in the gifting platform app 204. When the proxy payment card linked to user gift card account is provisioned to the digital wallet 208, spending proxy gift cards can be for example, via the user tapping her smart phone 202, or swiping/inserting their payment credential at a point of sale (POS). The user need not select or perform a redemption process.

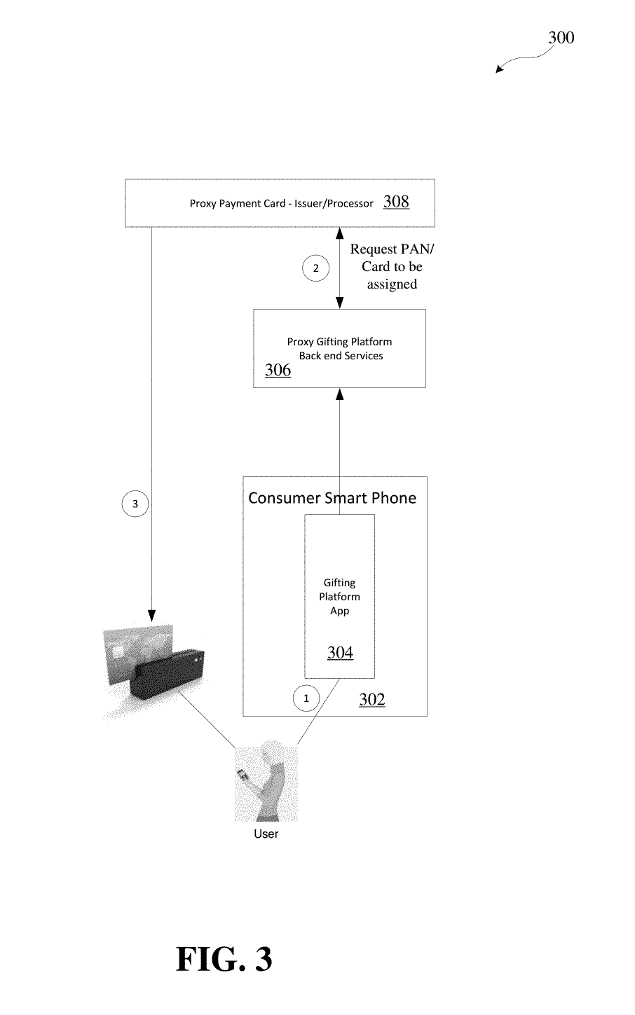

FIG. 3 illustrates a method 300 which can be used to issue a physical payment card to a user when the embodiment of a proxy payment card is implemented. The physical proxy payment card can be implemented via a magnetic stripe card, contactless card, an EMV card (Europay®, MasterCard®, Visa®), or could have all or any combination of these interfaces as is common practice by issuing banks. The physical payment card is a representative form of payment credential, which due to its availability and acceptance at merchant POS systems in the U.S. and globally can provide proxy gift card users with a global network of merchants to shop from. The physical card can be linked to a user's gift card account and used to pay for transactions affording the user the same or similar benefits as described above in relation to the embodiment of FIG. 2. To provision a physical payment card linked to a user's gift card account, the user can choose to receive it by inputting a request via exchange 1 in the gifting platform app 304. The gifting platform app 304 routes the request to the backend services 306, which sends, via an exchange 2, a request for the issuer/processor to assign a card number or Primary Account Number (PAN) and to issue the associated payment card to the user. In exchange 3, the user receives her physical payment card via mail or other standard delivery methods.

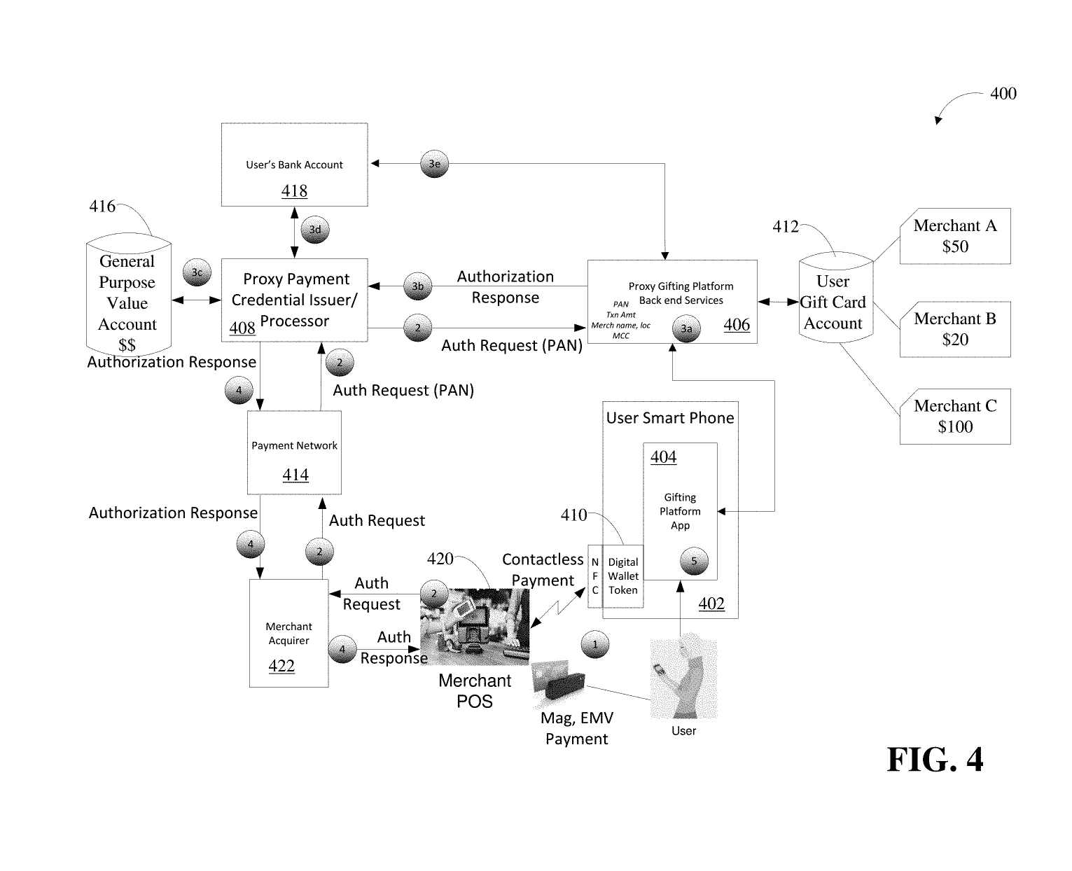

FIG. 4 illustrates a gift card system 400 where an embodiment is used to implement a payment using payment card as a proxy to a user's gift account. The user interacts with the gift card system 400 using a mobile computing device (e.g., a smart phone) 402. The mobile computing device 402 has been provisioned with a gifting platform app 404. Proxy gifting platform backend services 406 provides the infrastructure supporting the services and operation of the gifting platform app 404 and the proxy payment cards (digital and/or physical) associated with the user's gift card account. In the gift card system 400, the user has utilized the embodiments of FIGS. 2 and 3 and has provisioned a proxy payment card linked to her gift card account both in digital form in digital wallet 410 and in physical form. The user's gift card account 412 in the illustrated embodiment of FIG. 4 can include gift cards from Merchant A for $50, from Merchant B for $20 and from Merchant C for $100.

Advantageously, the embodiment of FIG. 4 need not go through a conventional “redeem” process as traditional gift card systems might do. The backend services 406 and the gifting platform app 404 keep track of which gift cards are in the user's gift account and apply them automatically when the user visits a merchant whose gift card is in the user's gift card account 412 and for a transaction for which the user utilizes a proxy payment card linked to the user gift card account 412. At the time of payment, the user may present her mobile computing device 402, as she might when using a digital wallet Near Field Communications (NFC) tap-and-pay at the merchant's POS 420. Alternatively, the user can utilize a physical proxy payment card provisioned according to the embodiment of FIG. 3. The physical proxy payment card can be swiped using a magnetic stripe, or inserted as with EMV cards.

Processing of a transaction in the system 400 occurs through existing payment rails. Accordingly, the merchants accepting a payment via the system 400 can process payments as they would their non-gift card transactions. The merchant need not implement a dedicated gift card processing infrastructure to accept a payment made through system 400. For example, a proxy payment credential issuer/processor 408 requests an authorization for a transaction amount from the payment network 414.

During payment authorization process, the issuer/processor 408 determines or detects whether a transaction is a transaction for which the gifting platform backend services 406 is to be queried. The issuer/processor 408 requests gift card authorization/approval from the gifting platform backend services 406. The gifting platform backend services 406 will check if the user account has gift card value for the merchant who is sending an authorization request. The gifting platform backend services 406 automatically debits the user gift card account 412 for the gift card value for the purchase and returns an approval response to the issuer-processor 408 as a full approval (3b).

The backend services 406 includes the ability to apply rules to the approval process. For example, in one implementation, rules 3a can limit the use of the user's proxy payment card (digital or physical) to use at a retailer or merchant by name. Examples of other rules that may be implemented are: geo-fence as with a campus or mall, limiting the usage of the payment card (digital, physical or both) to a geographical location (e.g. the payment card can be used at any retailer in a campus or mall or other predesignated physical area). Other rules can include limiting the usage of the proxy gift card of the system 400 to a merchant category, for example food, groceries or electronics. If the merchant category rule is implemented, the proxy gift card of the system 400 can be used at merchants in a pre-designated category.

The backend services 406 allows for automated combining of multiple gift card values to total an amount of a payment that may have been requested by the user. This is a form of automated combining of value. For example, adding retailer A and retailer B values in the user gift card account 412 can help the user to obtain funds for a transaction to complete. In some embodiments, if the gift card values in the gift card account 412 is not enough to pay a transaction in full, the proxy gifting platform 406 allows for a partial authorization to be used in authorization response (3b). The amount of gift card balances in the gift card account 412 is reduced to zero and the backend services 406 provides partial approval back to issuer-processor 408. The backend services 406 allows for a general-purpose value account 416 to be used to pay for the unpaid remainder of a transaction via exchange (3c). In some embodiments, the general-purpose value account 416 is held at the issuer-processor 408 on behalf of the user.

In another embodiment, in a partial authorization situation, the remaining value of the transaction can be provided by the user's account 418, for example the user's checking account, PayPal, or other account that holds funds to complete the transaction via an exchange (3d). In some embodiments, the user can pre-authorize and give access to the backend services 406 to use the user's bank account 418 to complete a transaction (3e).

In another embodiment, in a partial authorization situation, the transaction could go through the exchange 4 as a partial authorization back to the merchant. In this case, the merchant's POS 420 and its procedures will request the user to fund the remaining balance to complete the transaction. The merchant in this scenario processes a split payment at the POS 420. Issuer/processor 408 makes final full/partial approval or declines a transaction by sending a response back to financial payment network 417. Full/partial approval or decline responses are forwarded back to the merchant's POS 420. Merchant knows the transaction as a payment card, not a gift card. Thus, the merchant does not need to process this transaction through a dedicated gift card system.

In scenarios when the entire amount of a gift card value is not used, the user will still see a gift card along with its balance in her gifting platform app 404. The card can be exchanged, re-gifted, combined, split for the remaining value.

The described technology provides several benefits over existing systems both to the users of gift cards and the merchants. Unlike conventional gift card systems, there is no requirement to issue a gift card in physical or electronic form and process that gift card through a dedicated gift card issuance and payment processing infrastructure because the proxy methods and systems described above allow a traditional payment mechanism (e.g. ApplePay® NFC), with access to the user's gifting account by way of the proxy to accomplish gift card transactions through existing payment processing rails. Payment with a gift card and redemption of that gift card merge into one seamless action, automatically completing gift card transactions. Some embodiments dispense with the need to carry and use a physical gift card. This makes it much easier for the user to manage her gift cards. Partially used gift cards can be re-gifted and exchanged, combined, or split. This gives the user peace of mind that she won't leave a gift card unused and waste is reduced.

The backend services 406 is involved in the authorization decision to apply a gift card value. The described embodiments allow its users and merchants creative gifting opportunities such as geo-fencing and gifting limited to a geographical area such as a mall or campus, or gifting to one or more merchant categories rather than a single merchant by brand as has traditionally been the case.

In some embodiments, there is a user account established at the issuer-processor for payment processing, the described embodiments also allow real currency value to be held in that account and used automatically to fill any shortage that a user might have on a gift card purchase. For example, an $80 purchase when the user has only $50 on her gift card can be paid for via the $50 gift card and $30 from the real currency value held in the user's account.

For the merchants, they see the system 400 transactions as any other payment transaction without the need to perform any gift card processing or redemption. The user can just use tap to pay, and settlement can be accomplished along with all other network payments (e.g., Visa® or Mastercard® payments).

Failure Tracking

In some cases, the initial purchase and funding of a virtual gift card or proxy gift card fails due to insufficient user funds, fraudulent activity or other reasons. In some cases, such failure may not be detected before the failed gift card has gone through other transactions, such as exchanges or gifting to other users. A linked data structure system according to the disclosed embodiments can be used to track a gift card ledger from inception to expiration or expenditure maintaining the association with the initial purchaser.

A gift card system utilizing the described linked data structures can separate financial transactions from gift card transition transactions. Gift card transition transactions can include, sending a gift (e.g., the act of purchasing a digital gift card with real money funds to send to another individual or one's self); exchanging a gift (e.g., the act of changing the spending rules around an existing gift card on the platform where the card may be used with a different merchant, or different types of retailers in some specific categories); transferring a gift card (e.g., the act of transferring an existing gift card on the platform to another user on the platform); and redeeming a gift card (e.g., the act of using a gift card from the platform at a given participating merchant).

Gift cards on the described platform can be given a ledger account utilizing linked data structures described herein. The linked data structures allow for the sequential operation of debits, credits, and transfer between ledger accounts on the platform.

A financial transaction takes place at the time a gift card is purchased; when the payment is complete, a digital gift card is generated and delivered to the gift card recipient. The generated gift card can be used at a merchant, or a group of merchants, for example, based on a set of rules.

In some embodiments, at the time of generating a new gift card (or when a user purchases a gift card), the following ledger entries in the described linked data structures can be created: a “credit” on the recipient user's ledger account. This account is meant to keep track of how much money a user has in total. A “credit” on the recipient gift card ledger account. This account is meant to track a user's “balance” on her digital gift cards.

When a card is exchanged for a different retailer, the following ledger adjustments are made in the linked data structures: a “debit” on the existing card ledger account, a “credit” on the new card ledger account.

When a card is transferred to another user, the following ledger adjustments are made: a “debit” from the sending user's account. A “debit” from the sending user's digital gift card. A “credit” to the recipient user's account. The recipient receives the funds for the digital gift card. A “credit” on the recipient user's new digital gift card. The recipient now has a digital gift card on the platform, with the corresponding balance.

A gift card purchased on the platform, may be transferred to other users, and split multiple times into smaller values, and exchanged into new cards for different retailers. In the case of fraud, or payments being returned later in the process, dollar amounts can be traced back to the original purchaser, whose purchase has failed. In other words, card origination association is maintained by utilizing the described linked data structures.

Gift cards issued according to the described embodiments maintain their source of origin association. This allows a platform operator to trace cards that are in the platform, which have originated from a failed or returned payment. The operator can take appropriate measures to recover the lost funds.

Utilizing the described linked data structures ledger entries in the platform can be made immutable, and balance amounts cannot to be modified manually. Additionally, ledger lines can be tied to a starting balance, adjustment amount, and an ending balance. Ledger lines can be stored in immutable database records. This allows for financial, and transition transactions to be tracked, and not altered. Ledger lines implemented in the described data structures can supply an audit chain of movement of currency through the system (when the described data structures are used in a gift card system as described above).

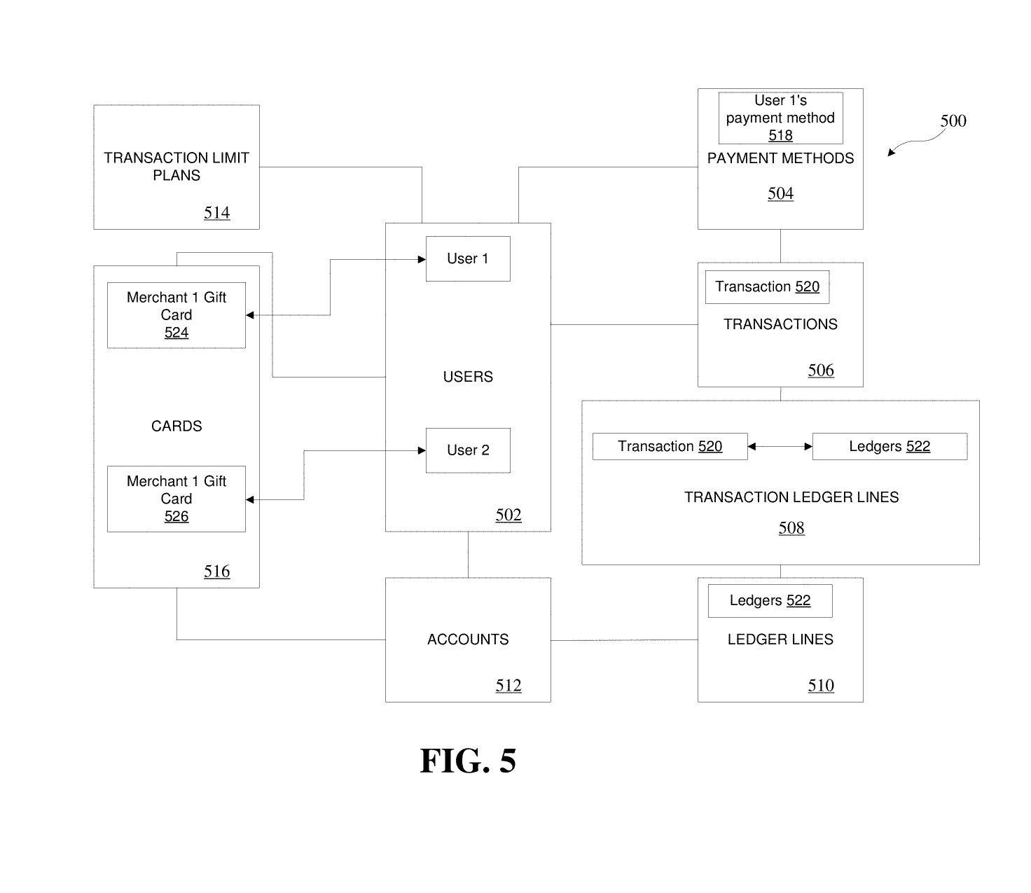

FIG. 5 illustrates an example linked data structure 500 according to an embodiment designed to allow for separating financial transactions from gift transitions and for failure tracking and fund recovery as described above. The linked data structure 500 can utilize ledgers associated with transactions on the gift card system to allow for tracking and reversing failed financial transactions or gift card transition transactions.

Failure can occur due to factors such as insufficient funds, system or database bugs, non-existent recipient, fraud or other factors. A failed transaction can lead to subsequent transactions to fail as well. For example, if a debit from a user's external financial institution account fails, the user's subsequent gifting transactions can also fail. The failure detection and alert may not be instantaneous and can potentially occur at some time after the initial failed transaction. When failure is detected, the ledgers can be used to reverse the failed transactions and restore the system to its state as it existed before the failed transaction.

The linked data structure 500 can include database tables such as Users 502, Payment Methods 504, Transactions 506, Transaction Ledger Lines 508, Ledger Lines 510, Accounts 512, Cards 516 and Transaction Limit Plans 514. Users 502 can include tables of data on users of the gift card system and their attributes. Transaction Limit Plans 514 can specify rules, circumstances and attributes associated with users' usage of the gift card system. For example, in some embodiments, users' activity might be capped to a dollar amount. Payment Methods 504 can contain data associating users of the gift card system to their preferred or prestored payment method for the purpose of funding their activity on the gift card platform. Payment methods can include, for example, credit card and/or bank account information.

Transactions 506 can record data related to transactions (financial or gift transition transactions) within the gift card system. Data in the Transactions 506 can trigger generating one or more ledgers in the Ledger Lines 510. Transaction Ledger Lines 508 maintains a mapping of data in Transactions 506 and the data in Ledger Lines 510. For example, when User 1 initiates the purchase and transfer of a $20 Merchant 1 gift card to User 2, a Transaction 520 in Transactions 506 is created indicating the activity. The payment method of User 1 from Payment Methods 504 is debited for $20. When the $20 is approved (by for example, the financial institution handling User 1's preferred payment method), one or more ledgers 522 are created in Ledger Lines 510.

Example Ledgers 522 in this scenario can include, a credit of $20 to User 1's account in Accounts 512, generating of a Merchant 1 Gift Card 524 associated with User 1 in Cards 516 or if User 1 already has a Merchant 1 Gift Card 524 in Cards 516, increasing the balance of Merchant 1 Gift Card 524 in the amount of $20. Further Ledgers 522 in this scenario can include data associated with the gift card transition transactions. For example, debiting user 1's account in Accounts 512 in the amount of $20, crediting User 2's account in Accounts 512 by $20, generating a Merchant 1 Gift Card 526 associated with User 2 and/or increasing the balance of the Merchant 1 Gift Card 526 in the amount of $20 in Cards 516 if it already exists and reducing the balance of Merchant 1 Gift Card 524 in the amount of $20.

In some embodiments, the linked data structure 500 can include a Transaction Ledger Lines 508 which can contain a mapping of data in Transactions 506 and data in Ledger Lines 510 (e.g., a mapping between Transaction 520 and Ledgers 522). When there is a failure in Transaction 520 and/or Ledgers 522 or elsewhere in the chain of transactions, the data in Transaction Ledger Lines 508, Ledger Lines 510 and/or Transaction 520 are linked and can be used to trace the failure to its source and reverse the failed transactions restoring the state of the linked data structure 500 to its pre-failure state.

In the example given above and in one implementation, if User 2 cannot be found, the data in Ledgers 522 containing the instruction to generate or adjust Merchant 1 Gift Card 526 associated with User 2 fails. Ledgers 522 can be queried to determine that prior to failed transaction (“instruction to credit/generate Merchant 1 Gift Card 526 associated with User 2”), there was an instruction to debit Merchant 1 Gift Card 524 associated with User 1 and to debit User 1's account in Accounts 512. The instructions to debit Merchant 1 Gift Card 524 and debit User 1's account in Accounts 512 can be reversed to restore Merchant 1 Gift Card 524's original balance prior to the attempted transfer. In another scenario, if the payment method 518 declines User 1's request for $20, the subsequent transactions fail. The Ledgers 522, Transaction Ledger Lines 508 and/or the Transaction 520 are linked and can be used to reverse transactions associated with the initial failure. For example, Merchant 1 Gift Card 526 associated with User 2 can be debited $20, User 2's account in Accounts 512 can be debited $20, Merchant 1 Gift Card 524 can be debited $20, and User 1's account in Accounts 512 can be debited $20.

Above examples are for illustration purposes only. Persons of ordinary skill in the art can envision alternate implementations where transactions can be recorded and stored in alternate ways without departing from the spirit of the described technology.

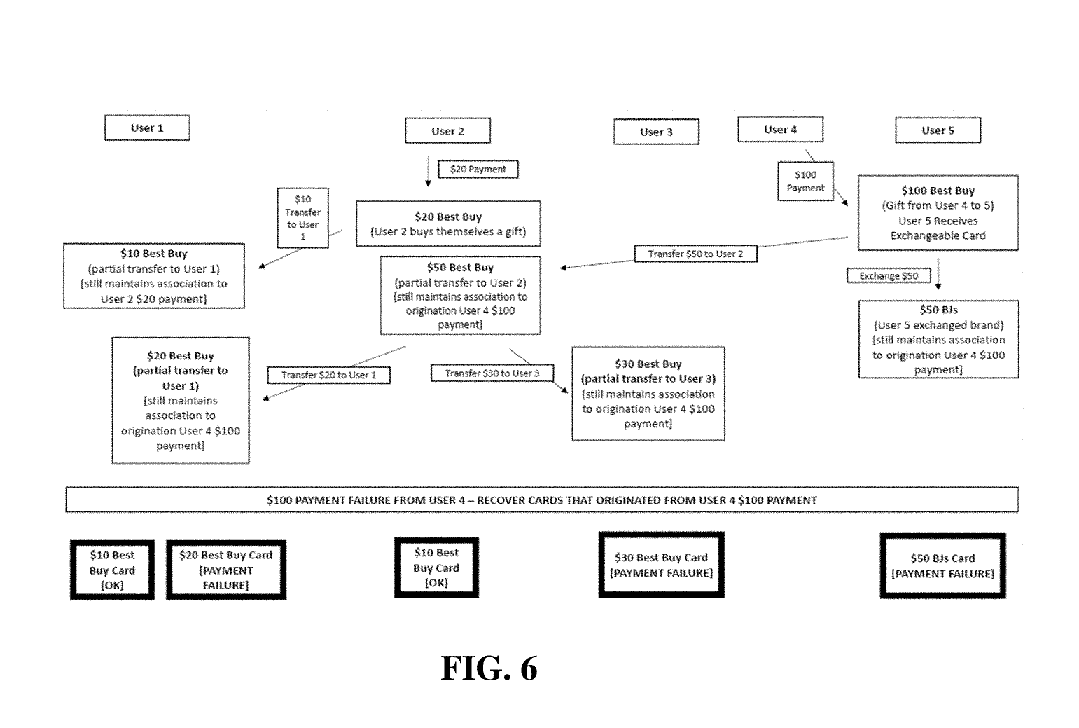

FIG. 6 illustrates an example payment failure tracking according to an embodiment. Users 1 through 5 engage in gift card activity utilizing an embodiment of a virtual gift card or proxy gift card as described above. The gift card or associated financial transactions between users 1-5 can be recorded via ledger entries in linked databases as described above. When User 4's purchase of a $100 Best Buy® gift card fails, the subsequent gift card transactions linked to that initial purchase also fail. In the example shown, User 3 is a recipient of $30 Best Buy® gift card from the original $100 failed gift card purchased by User 4. User 3's attempt to use the $30 Best Buy® gift card fails. Similarly, FIG. 6 illustrates other gift card transactions that are not linked to the initial failed purchase by User 4 and those transactions succeed (e.g., User 1's use of $10 Best Buy® card, traceable to a successful initial purchase by User 2, succeeds).

The described and illustrated data structures, sub-data structures and modules operate to build one or more linked databases. As described above, one application includes implementing digital gift card systems. Other technical uses for the described databases exist and persons of ordinary skill in the art can implement the described technology in other technical fields without departing from the spirit of the described technology.

What is claimed is:

1. An electronically-implemented method comprising:
receiving an input from a first user indicating a first type and a first value of a gift card;
receiving a request from the first user to donate the gift card to a second user;
updating a transactions database with program instructions associated with the first user's request;
updating a ledger lines database with program sub-instructions to carry out the first user's request;
updating a transaction ledger lines database with a mapping of data in the transactions database and data in the ledger lines database; and
executing the program instructions in the transactions database and the program sub-instructions in the ledger lines database.

2. The method of claim 1, wherein program sub-instructions comprise computer instructions to:
withdraw funds in the amount of the first value from a bank account of the first user;
credit a first user's account in an accounts database in the amount of the first value;
update a cards database by associating a virtual gift card of the first value and the first type to the first user;
debit the first user's account in the accounts database in the amount of the first value;
debit the virtual gift card of the first user in the cards database in the amount of the first value;
credit an account of the second user in the accounts database in the first value;
generate, in the cards database, a virtual gift card associated with the second user in the amount of the first value.

3. The method of claim 2 further comprising:
receiving a modification request from the second user for modifying the first type or the first value of the virtual gift card associated with the second user; and
updating the transactions database, the ledger lines database and the transaction ledger lines with program instructions to modify the virtual gift card associated with the second user according to the modification request.

4. The method of claim 3, further comprising:
receiving a request from the second user for redeeming the virtual gift card associated with the second user;
purchasing, from a gift card provider, a gift card in the value and type of the virtual gift card; and
presenting an identifier to the second user, wherein the identifier corresponds to the purchased gift card.

5. The method of claim 3, wherein modification request comprises: adding, splitting, combining, or exchanging the virtual gift card associated with the second user for another type and/or value.

6. The method of claim 3, further comprising: providing a proxy payment card associated with the second user, wherein the second user can use the proxy payment card at a point of sale to purchase in the amount associated with the modified virtual gift card, in an amount less than or equal to the modified virtual gift card or in an amount more than the modified virtual gift card, wherein the remainder amount is supplemented automatically from other virtual gift cards associated with the second user.

7. The method of claim 6, wherein the proxy payment card is provisioned in a digital wallet, implemented in a physical card or both.

8. The method of claim 2, wherein the transaction ledger lines database is used to trace an error in executing program instructions and/or program sub-instructions.

9. The method of claim 1 further comprising: authenticating the first user with cell phone career data and/or two-factor authentication.

10. A linked data structure comprising:
a users database configured to receive and store identification and authentication information of a plurality of users;
a transactions database configured to receive instructions associated with managing gift card transitions and gift card transactions of the plurality of users;
a ledger lines database configured to store one or more program sub-instructions based on the instructions associated with managing gift card transitions and gift card transactions;
a transaction ledger lines database configured to generate and store a mapping of data in the transactions database and data in the ledger lines database; and
a cards database configured to generate and store virtual gift cards associated with the plurality of users in the users database.

11. The linked data structure of claim 10 further comprising: a payment methods database configured to receive and store one or more payment methods associated with the plurality of users, wherein payment methods comprise links to bank accounts of the plurality of the users and sub-instructions comprise program code to withdraw funds from the bank accounts in the amount of the virtual gift cards.

12. The linked data structure of claim 10, wherein the instructions in the transactions database comprise instructions from a first user to purchase a gift card of a first value and first type and donate the gift card to a second user.

13. The linked data structure of claim 12 further comprising an accounts database and wherein the sub-instructions in the ledger lines comprise instructions to:
withdraw funds in the amount of the first value from a bank account of the first user;
credit a first user's account in the accounts database in the amount of the first value;
update the cards database by associating a virtual gift card of the first value and the first type to the first user;
debit the first user's account in the accounts database in the amount of the first value;
debit the virtual gift card of the first user in the cards database in the amount of the first value;
credit an account of the second user in the accounts database in the first value;
generate, in the cards database, a virtual gift card associated with the second user in the amount of the first value.

14. The linked data structure of claim 13, wherein the instructions in the transactions database further comprises instructions based on a request from the second user to modify the type and value of the virtual gift card associated with the second user.

15. The linked data structure of claim 14, wherein the request from the second user comprises: adding, splitting, combining, or exchanging the virtual gift card associated with the second user for another type and/or value.

16. The linked data structure of claim 13, wherein the sub-instructions comprise updating the transactions database, the ledger lines database and the transaction ledger lines with program instructions to modify the virtual gift card associated with the second user according to the request from the second user.

17. The linked data structure of claim 10, wherein the instructions in the transactions database further comprises instructions based on a user's request to redeem a virtual gift card and the sub-instructions comprise instructions to purchase a gift card from a gift card vendor in the amount and value of the virtual gift card.

18. The linked data structure of claim 10, wherein the instructions in the transactions database and the sub-instructions in the ledger lines database are generated to support usage of proxy payment cards associated with the virtual gift cards.

19. The linked data structure of claim 10, wherein the mapping in the transaction ledger lines database is used to trace a failure in a gift card transition and/or a gift card transaction.

20. A mobile application comprising the linked data structure of claim 10.
